(19) United States
(12) Patent Application Publication
(10) Pub. No.: US 2026/0055819 A1
(43) Pub. Date: Feb. 26, 2026

(54) STRUCTURAL COMPONENT

(71) Applicant: NIFCO INC., Yokosuka-shi (JP)

(72) Inventors: Yoshimi ARAI, Yokosuka-shi (JP); Ryosuke YAMADA, Yokosuka-shi (JP)

(21) Appl. No.: 19/271,799

(22) Filed: Jul. 17, 2025

(30) Foreign Application Priority Data
Aug. 22, 2024 (JP) 2024-141074

(51) Int. Cl. F16K 17/04; F16J 15/08; F16K 27/12

(52) U.S. Cl. CPC F16K 17/046; F16J 15/0818; F16K 27/12

(57) ABSTRACT

A structural component is configured to be attached to a surface of a target object including a flow path. The structural component includes a case including a communicating portion that is configured to communicate with the flow path of the target object, and a reinforcing portion connected to at least two points on an inner wall of the communicating portion; and a gasket provided to the case on a downstream side in a flow direction of a fluid in the communicating portion, the gasket surrounding the communicating portion in a plan view. The gasket includes an engagement portion engaging the case, and at least a part of the engagement portion overlaps the reinforcing portion in the flow direction.

### CROSS-REFERENCE TO THE RELATED APPLICATION

The present application claims priority of Japanese Patent Application No. 2024-141074 filed on Aug. 22, 2024, the disclosure of which is incorporated herein.

### BACKGROUND OF THE INVENTION

### 1. Field of the Invention

The present invention relates to a structural component attached to a surface of a target object provided with a flow path.

### 2. Description of the Related Art

A pressure relief valve is sometimes connected to an interior of an automobile. The pressure relief valve includes a case having a communicating portion for causing an internal space of the pressure relief valve to communicate with an external space and a gasket positioned at a downstream side in a flow direction of a fluid in the communicating portion in a manner surrounding the communicating portion. The pressure relief valve is connected, for example, to a battery pack installed in an automobile. In this case, the pressure inside the battery pack can be regulated by the pressure relief valve.

Patent Literature 1: Japanese Unexamined Patent Application Publication No. 2023-175485

The gasket of the pressure relief valve (structural component) can be attached to the case by providing an engagement portion on the gasket and engaging the engagement portion with the case. However, a fluid flowing in a communicating portion of the case possibly directly hits an engagement portion of the gasket, depending on the position for the engagement portion of the gasket to be engaged with the case. In this case, it is possible that the engagement portion of the gasket is disengaged from the case due to the fluid directly hitting thereon. It is also possible that pressure loss of the fluid flowing through the communicating portion is caused by the fluid directly hitting on the engagement portion of the gasket.

### SUMMARY OF THE INVENTION

An object of the present invention is to provide a structural component that can solve the above problems.

The present invention relates to the following [1] to [10].

[1] A structural component attached to a surface of a target object including a flow path, the structural component including:
a case including a communicating portion that communicates with the flow path of the target object and a reinforcing portion connected to at least two points on an inner wall of the communicating portion; and
a gasket provided to the case on a downstream side in a flow direction of a fluid in the communicating portion, the gasket surrounding the communicating portion in a plan view, in which
the gasket includes an engagement portion engaging the case, and
at least a part of the engagement portion overlaps the reinforcing portion in the flow direction.

[2] The structural component according to [1] may include: a valve member including a cover that covers the communicating portion in a closed position, the valve member being movable from a closed position to open the communicating portion, in which
the gasket may be interposed between the case and the valve member.

[3] In the structural component according to [1] or [2], a ratio of an area occupied by the reinforcing portion to an entire area surrounded by the inner wall of the communicating portion in a plan view may be 20% or less.

[4] In the structural component according to any one of [1] to [3], at least a part of the engagement portion may overlap the reinforcing portion from a downstream side in the flow direction.

[5] In the structural component according to any one of [1] to [4], the gasket may further include an annular gasket body, and
the engagement portion may include an extension extending from an inner peripheral portion of the gasket body and a hooking portion connected to the extension and engaged with the case.

[6] In the structural component according to [5], at least a part of the extension may overlap the reinforcing portion in the flow direction.

[7] In the structural component according to [5] or [6], the case may further include a cut portion provided in the inner wall of the communicating portion, and
at least a part of the extension may be positioned in the cut portion.

[8] In the structural component according to any one of [5] to [7], the case may further include a hooked portion provided to the communicating portion and engaged with the hooking portion.

[9] In the structural component according to [8], the hooked portion may engage with a part of the hooking portion that does not overlap the reinforcing portion in plan view.

[10] In the structural component according to any one of [1] to [9], the target object may be an enclosure of a battery pack.

According to the present invention, disadvantages caused when the fluid that flows in the communicating portion of the case directly hits the engagement portion of the gasket can be suppressed.

### BRIEF DESCRIPTION OF THE DRAWINGS

FIG. 1 is a perspective view illustrating an example of a structural component and a target object.

FIG. 2 is a plan view illustrating the example of the structural component.

FIG. 3 is a side view illustrating the example of the structural component.

FIG. 4 is a perspective view illustrating an example of a case, a gasket, and a second gasket.

FIG. 5 is a perspective view illustrating the example of the case, the gasket, and the second gasket.

FIG. 6 is a cross-sectional view of the structural component taken along VI-VI line in FIG. 2.

FIG. 7 is a cross-sectional view of the structural component taken along VII-VII line in FIG. 2.

FIG. 8 is a cross-sectional view illustrating an example of the structural component attached to the target object.

FIG. 9 is a perspective view illustrating a part of FIG. 5 in an enlarged manner.

FIG. 10 is a plan view illustrating one of engagement portions.

FIG. 11 is a cross-sectional view illustrating an example of an operation of the pressure relief valve.

### DETAILED DESCRIPTION OF EMBODIMENTS

An exemplary embodiment of the present invention will be described below with reference to attached drawings. In the drawings attached to the present specification, the scale, the ratio of length to width and height, and the like have been changed and exaggerated from those of the actual products as appropriate for the sake of easy understanding.

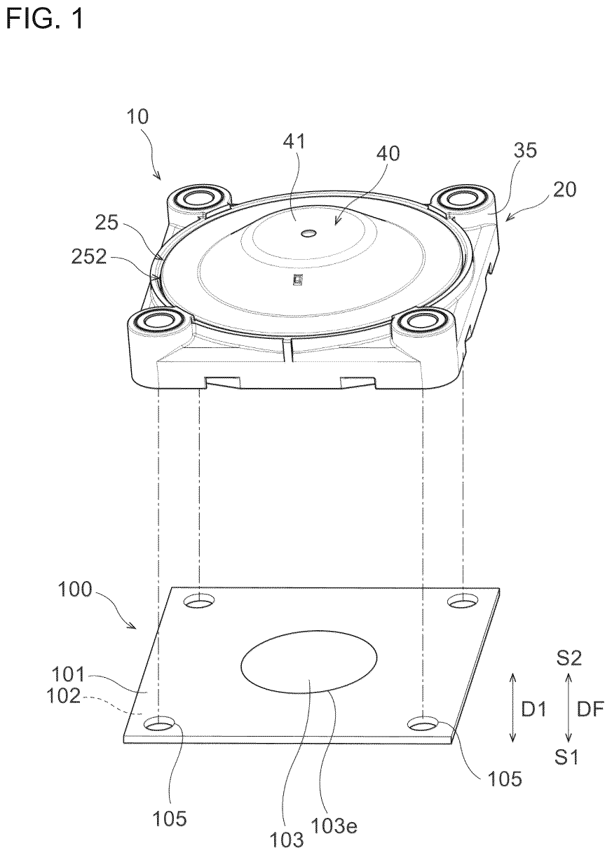

FIG. 1 is a perspective view illustrating an example of a structural component 10 and a target object 100. The structural component 10 is attached to a top surface 101 of the target object 100 that includes a flow path 103. In the example of FIG. 1, the target object 100 is an enclosure of a battery pack and the structural component 10 is a pressure relief valve mounted on the enclosure. The pressure relief valve is a device used to regulate the pressure inside the battery pack. For example, the pressure relief valve operates to release a fluid (e.g., a gas inside a battery pack) to the outside when the pressure inside the battery pack exceeds a threshold. Devices, such as battery cells, are housed inside the battery pack.

The target object 100 has the top surface 101, a back surface 102, and the flow path 103. The flow path 103 is a structure for releasing the fluid (e.g., the gas inside the target object 100) to the outside. The flow path 103 is, for example, an opening penetrating the enclosure of the target object 100. The flow path 103 is covered with the structural component 10. The structural component 10 overlaps an outer edge 103e of the flow path 103 in a plan view. The term “in a plan view” herein means that an object is viewed along a normal direction of the top surface 101 of the target object 100. The top surface 101 faces the structural component 10. The back surface 102 is located opposite the top surface 101 in the thickness direction.

The target object 100 has a plurality of fastening holes 105. Fasteners are inserted into the fastening holes 105 to fix the structural component 10 to the target object 100. Examples of the fasteners include bolts.

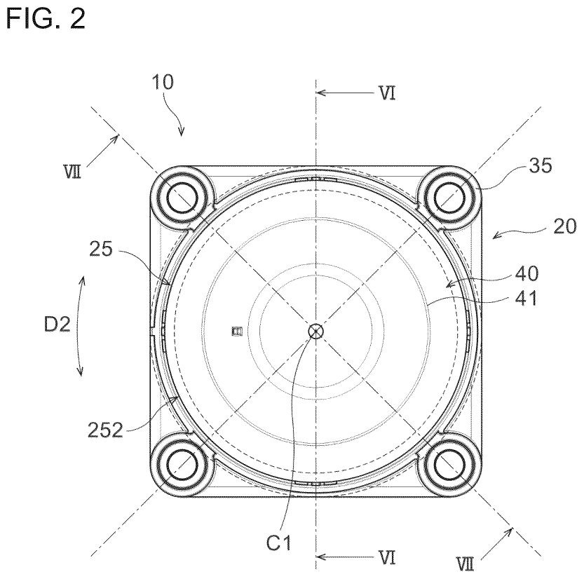

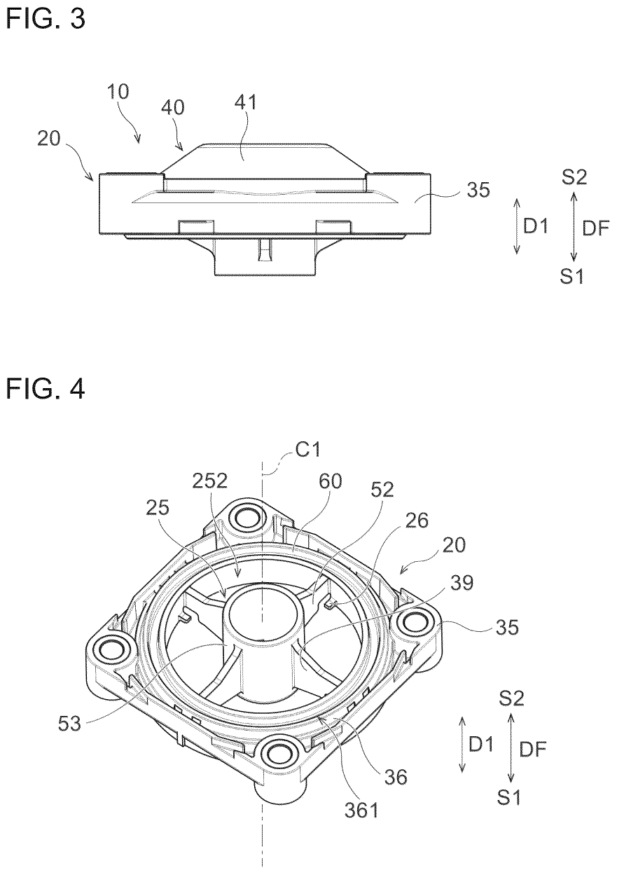

FIG. 2 is a plan view illustrating the example of the structural component 10. FIG. 2 corresponds to an illustration illustrating the structural component 10 in a plan view. FIG. 3 is a side view illustrating the example of the structural component 10. As illustrated in FIGS. 1 to 3, the structural component 10 includes a case 20. In the example illustrated in FIGS. 1 to 3, the structural component 10 also includes a valve member 40. The case 20 is provided with a communicating portion 25 that communicates with the flow path 103 of the target object 100. When the fluid inside the target object 100 is released to the outside, the fluid flows into the communicating portion 25 through the flow path 103. Accordingly, the fluid flows within the communicating portion 25 in a flow direction DF from an upstream side s1 to a downstream side s2. The upstream side s1 is a side for the flow path 103 of the target object 100 to be located with respect to a hole 252 of the communicating portion 25. The downstream side s2 is a side opposite the side for the flow path 103 of the target object 100 to be located with respect to the hole 252 of the communicating portion 25.

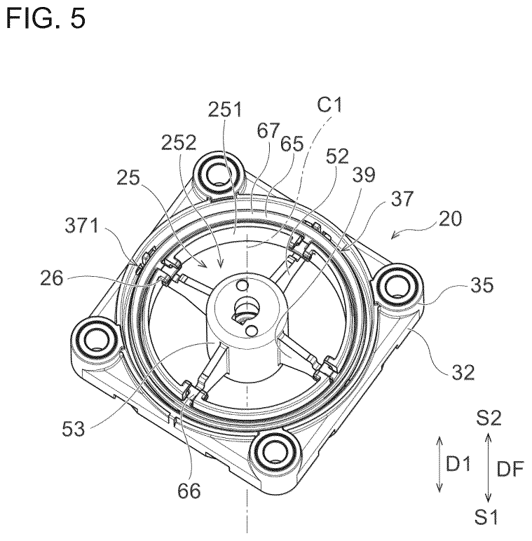

Although not illustrated in FIG. 1, the structural component 10 further includes a gasket 65. Although not illustrated in FIG. 1, the structural component 10 further includes a second gasket 60. FIG. 4 is a perspective view illustrating the case 20 and the second gasket 60 of the structural component 10 viewed from a side facing the top surface 101 when the structural component 10 is fixed to the top surface 101 of the target object 100. FIG. 5 is a perspective view illustrating the case 20 and the gasket 65 of the structural component 10 viewed from a side opposite the side facing the top surface 101 of the target object 100 when the structural component 10 is fixed to the top surface 101.

The gasket 65 is placed on the case 20 at the downstream side s2 in the flow direction DF. In the present exemplary embodiment, the gasket 65 is interposed between the case 20 and the valve member 40. In a plan view, the gasket 65 surrounds the communicating portion 25 of the case 20. The gasket 65 is in close contact with the case 20 and a cover 41 of the valve member 40 when the valve member 40 is in a closed position to provide a tight seal between the case 20 and the cover 41 of the valve member 40. The sealability between the case 20 and the cover 41 of the valve member 40 at the closed position can be enhanced by interposing the gasket 65 between the case 20 and the valve member 40.

In the present exemplary embodiment, the gasket 65 has a substantially annular shape. The gasket 65 has an engagement portion 66 to be engaged with the case 20. In the example illustrated in FIG. 5, the gasket 65 also has an annular gasket body 67. When the valve member 40 is in the closed position, the gasket body 67 of the gasket 65 is in close contact with the case 20 and the cover 41 of the valve member 40 to provide a tight seal between the case 20 and the cover 41 of the valve member 40. The engagement portion 66 extends from the gasket body 67. The gasket 65 is attached to the case 20 by engagement of the engagement portion 66 with the case 20. The gasket 65 may include a plurality of the engagement portions 66. In the example illustrated in FIG. 5, the gasket 65 has four engagement portions 66. Details of the engagement portion 66 will be described later.

The second gasket 60 is interposed between the top surface 101 of the target object 100 and the case 20. The second gasket 60 surrounds the flow path 103 in a plan view. The second gasket 60 is in close contact with the case 20 and the top surface 101 when the structural component 10 is attached to the top surface 101 of the target object 100 to provide a tight seal between the case 20 and the top surface 101. In the present exemplary embodiment, the second gasket 60 has an annular shape.

The case 20 has a communicating portion 25 and a reinforcing portion 39. The case 20 of the present exemplary embodiment also has a fastening portion 35.

In the present exemplary embodiment, the case 20 further has a groove portion 37 that receives a part of the gasket 65. In the example illustrated in FIG. 5, the gasket body 67 is received in the groove portion 37. The groove portion 37 is open to the cover 41 of the valve member 40. A part of the gasket 65 protrudes from the groove portion 37.

In the present exemplary embodiment, the case 20 further includes a receiver portion 36 having a receiver groove 361 that receives the second gasket 60. When the structural component 10 is attached to the top surface 101 of the target object 100, the receiver groove 361 is open to the top surface 101. A part of the second gasket 60 protrudes from the receiver groove 361.

In the present exemplary embodiment, the communicating portion 25, the reinforcing portion 39, the fastening portion 35, the receiver portion 36, and the groove portion 37 are integrally constructed. The case 20 may be a component made through an injection molding.

The case 20 may contain a resin. The target object 100 also may contain a resin.

As described above, the communicating portion 25 communicates with the flow path 103 of the target object 100. The communicating portion 25 has a hole 252 penetrating the case 20. A wall face of an inner side of the communicating portion 25 that defines the hole 252 will be referred to as an inner wall 251 of the communicating portion 25. The term “inner” herein refers to a direction toward the center of the flow path 103 in a plan view. The term “outer” herein refers to a direction away from the center of the flow path 103 in a plan view. The communicating portion 25 may have a cylindrical shape. The communicating portion 25 is located at an inner side of the second gasket 60 in a plan view.

The fastening portion 35 is a part of the case 20 to be fastened to the top surface 101 of the target object 100. The case 20 of the present exemplary embodiment includes a plurality of fastening portions 35 (specifically, four fastening portions 35). The fastening portions 35 are arranged in a circumferential direction D2 along a circumference of the structural component 10 in a plan view. A center point for determining the circumferential direction D2 is defined at a geometric center C1 of an area surrounded by the inner wall 251 of the communicating portion 25 in a plan view. The fastening portions 35 may be spaced at equal intervals in the circumferential direction D2 along the circumference of the structural component 10 in a plan view. The fastening portions 35 each include a hole for a fastener to be inserted. The holes of the fastening portions 35 respectively overlap the fastening holes 105 in the target object 100. In the present exemplary embodiment, the fastening portion 35 is a columnar (specifically, cylindrical) portion that is provided with the hole for the fastener to be inserted.

The valve member 40 includes a cover 41 that covers the communicating portion 25 of the case 20 in the closed position. The valve member 40 is movable from the closed position to open the communicating portion 25. The valve member 40 moves to open the communicating portion 25 when the pressure inside the target object 100 exceeds a threshold. In the structural component 10 illustrated in FIG. 1, when the pressure inside the target object 100 exceeds the threshold, the valve member 40 moves so that the cover 41 moves away from the case 20 in a first direction D1. In the illustrated example, the first direction D1 is a normal direction of the top surface 101 of the target object 100. In the illustrated example, the first direction D1 is parallel to the flow direction DF. Although not illustrated, the valve member 40 may be configured to move from the closed position in a direction other than the first direction D1 to open the communicating portion 25. Although not illustrated, the valve member 40 may be configured to move from the closed position in a direction other than the flow direction DF to open the communicating portion 25.

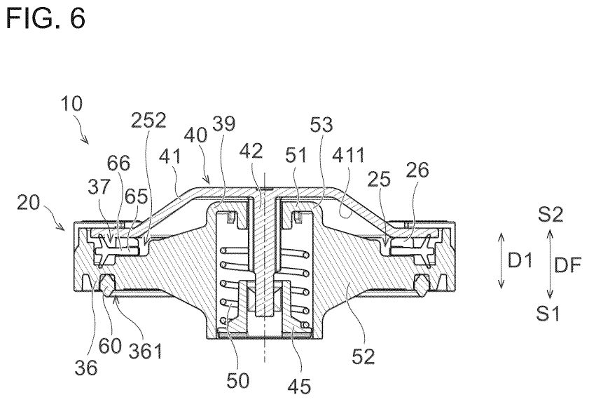

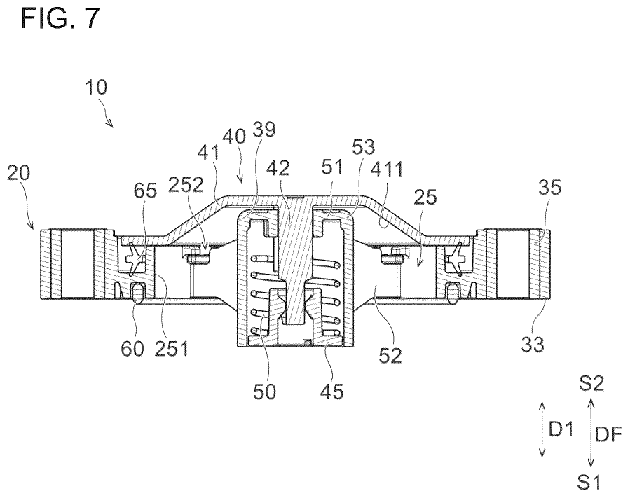

FIG. 6 is a cross-sectional view of the structural component 10 taken along a VI-VI line in FIG. 2. FIG. 7 is a cross-sectional view of the structural component 10 taken along a VII-VII line in FIG. 2. As illustrated in FIGS. 6 and 7, the structural component 10 may be equipped with an elastic member 50. The elastic member 50 biases the valve member 40 toward the target object 100 in the first direction D1. The elastic member 50 expands and contracts in the first direction D1 in response to the movement of the valve member 40 in the first direction D1. The elastic member 50 is, for example, a spring. When the pressure inside the target object 100 becomes greater than the biasing force applied on the valve member 40 by the elastic member 50, the valve member 40 moves away from the case 20 in the first direction D1.

The valve member 40 may include a shaft 42 extending from an inner surface 411 of the cover 41 toward the case 20. The inner surface 411 of the cover 41 is a surface of the cover 41 that faces the top surface 101 when the structural component 10 is attached to the top surface 101 of the target object 100. The shaft 42 may be inserted into the elastic member 50.

As illustrated in FIGS. 6 and 7, an end lock 45 may be attached to an end of the shaft 42. The end lock 45 may be in contact with an end of the elastic member 50.

In the example illustrated in FIGS. 6 and 7, the reinforcing portion 39 of the case 20 includes a shaft receiver 53 and a beam 52. The shaft receiver 53 is a part receiving at least a part of the shaft 42 of the valve member 40. In accordance with the movement of the shaft 42 of the valve member 40 along the shaft receiver 53, the valve member 40 moves to change its position relative to the case 20. In the example illustrated in FIGS. 6 and 7, the shaft receiver 53 receives at least a part of the elastic member 50 and the shaft 42 of the valve member 40. In the example illustrated in FIGS. 6 and 7, a part of the shaft 42 of the valve member 40 including the end lock 45 is received by the shaft receiver 53. An entirety of the elastic member 50 is also received in the shaft receiver 53. In the example illustrated in FIGS. 6 and 7, the shaft receiver 53 is in a columnar (specifically, cylindrical) shape extending in the first direction D1. The beam 52 is a part extending in a radial direction of the communicating portion 25 to connect the shaft receiver 53 to the inner wall 251 of the communicating portion 25. In the example illustrated in FIGS. 4 and 5, the beam 52 is a plate-shaped component having faces parallel to the radial direction of the communicating portion 25 and the first direction D1. In the example illustrated in FIGS. 4 and 5, the case 20 includes four beams 52. As illustrated in FIGS. 6 and 7, the shaft receiver 53 of the case 20 may have a stopper portion 51 that contacts an end of the elastic member 50 opposite the end of the elastic member 50 that contacts the end lock 45.

The reinforcing portion 39 is a part connected to at least two points on the inner wall 251 of the communicating portion 25. The reinforcing portion 39 is connected to a plurality of points on the inner wall 251 of the communicating portion 25 to support the inner wall 251 of the communicating portion 25. The reinforcing portion 39 suppresses deformation and/or damage to the communicating portion 25 even when a significantly large internal pressure is applied to an interior of the hole 252 of the communicating portion 25.

As an example, the reinforcing portion 39 is connected to the inner wall 251 of the communicating portion 25 at two or more points including a first connection point and a second connection point. In a plan view, an angle defined by a straight line connecting the first connection point and the geometric center C1 and a straight line connecting the second connection point and the geometric center C1 is 90 degrees or more. The angle may be 120 degrees or more, 150 degrees or more, or 180 degrees or more.

The above-described shaft receiver 53 and the beam 52 of the case 20 can be considered to be a part of the reinforcing portion 39. Specifically, in the example illustrated in FIGS. 6 and 7, the reinforcing portion 39 of the case 20 includes the shaft receiver 53 and the beam 52. Especially, in the example illustrated in FIGS. 6 and 7, the reinforcing portion 39 is formed of the shaft receiver 53 and the beam 52. Although not illustrated, the reinforcing portion 39 may include none of the shaft receiver 53 and the beam 52. The configuration of the reinforcing portion 39 is not specifically limited as long as the inner wall 251 of the communicating portion 25 can be supported. Although not illustrated, the reinforcing portion 39 may be a plate-shaped or rod-shaped component connected to a plurality of points on the inner wall 251 of the communicating portion 25 without being connected to the shaft receiver 53. In this case, the reinforcing portion 39 may be a grid-shaped or, alternatively, cross-shaped (i.e., “+” shaped) component in a plan view.

The reinforcing portion 39, which supports the inner wall 251 of the communicating portion 25 to suppress deformation and/or damage to the communicating portion 25, secures an area for the fluid to flow in the communicating portion 25. As an example, a ratio of the area occupied by the reinforcing portion 39 to an entire area of the communicating portion 25 surrounded by the inner wall 251 in a plan view is 20% or less. The ratio may be 15% or less, or 10% or less. With the above-described upper limit defined for the ratio, a sufficient area for the fluid to flow can be secured in the communicating portion 25.

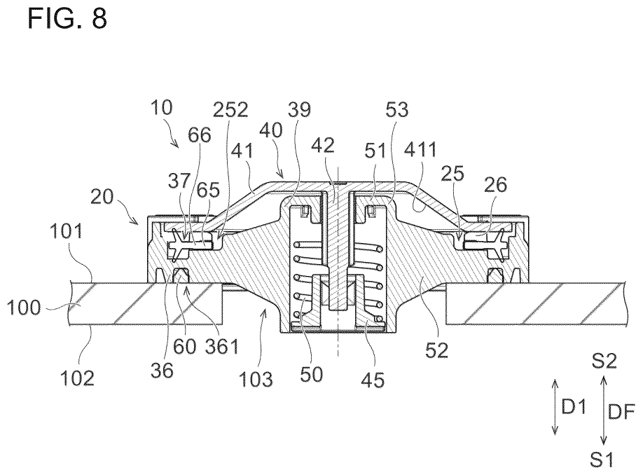

FIG. 8 is a cross-sectional view illustrating an example of the structural component 10 attached to the target object 100. In the cross-sectional view in FIG. 8, the structural component 10 is cut along the VI-VI line in FIG. 2 as in FIG. 6. As illustrated in FIG. 8, the second gasket 60 may be disposed while being compressed between the case 20 and the top surface 101 of the target object 100. The second gasket 60 may include a compressible elastic material.

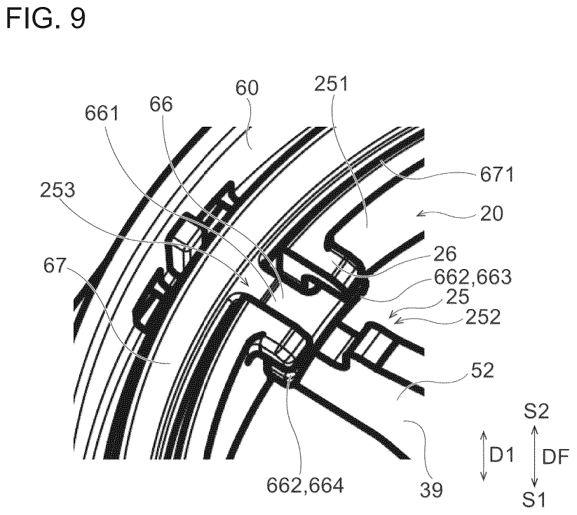

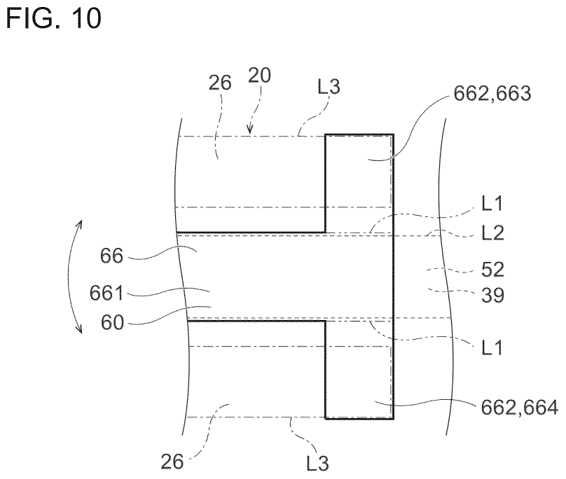

Details of the engagement portion 66 of the gasket 65 and a part of the case 20 engaged with the engagement portion 66 will be described below. FIG. 9 is a perspective view illustrating one of the engagement portions 66 illustrated in FIG. 5 and the part of the case 20 engaged with one of the engagement portions 66 in an enlarged manner. FIG. 10 is a plan view illustrating one of the engagement portions 66 illustrated in FIG. 5 in an enlarged manner together with the position of the reinforcing portion 39 and a position of a later-described hooked portion 26 engaged with the engagement portion 66. The broken lines with a sign “L2” illustrated in FIG. 10 represent the position of the reinforcing portion 39. The dashed broken lines with a sign “L3” illustrated in FIG. 10 represent the position of the hooked portion 26 engaged with the engagement portion 66.

In the example illustrated in FIGS. 9 and 10, the engagement portion 66 includes an extension 661 and a hooking portion 662. The extension 661 is a part extending from an inner peripheral portion 671 of the gasket body 67. The inner peripheral portion 671 is a peripheral portion of the annular gasket body 67 that faces inward in a plan view. In the example illustrated in FIG. 10, the extension 661 extends in the radial direction of the communicating portion 25. The hooking portion 662 is a part connected to the extension 661 and engaged with the case 20. In the example illustrated in FIG. 10, the hooking portion 662 extends in the circumferential direction D2. The hooking portion 662 is provided on both sides of the extension 661 in the circumferential direction D2. Specifically, the hooking portion 662 includes a first portion 663 located at one side of the extension 661 in the circumferential direction D2 and a second portion 664 located at a side of the extension 661 opposite the side provided with the first portion 663 in the circumferential direction D2. The hooking portion 662 is connected to an inner end of the extension 661. Virtual lines L1 (dash-dotted lines) each illustrating, for the sake of convenience, a border between the extension 661 and the hooking portion 662 are illustrated in FIG. 10. As illustrated in FIG. 10, the border between the extension 661 and the hooking portion 662 is defined by the virtual lines L1 extending in the direction for the extension 661 to be extended. The above-described engagement portion 66 including the extension 661 and the hooking portion 662 can keep engagement with the case 20 stable.

In the example illustrated in FIG. 9, the case 20 further includes the hooked portion 26 provided to the communicating portion 25 to be engaged with the hooking portion 662. The hooked portion 26 is provided on the inner wall 251 of the communicating portion 25. In the example illustrated in FIG. 9, the hooked portion 26 extends from the inner wall 251 in the radial direction of the communicating portion 25. The hooked portion 26 protrudes inward from the inner wall 251. The hooked portion 26 is connected to one point on the inner wall 251. The hooked portion 26 is provided so that two hooked portions 26 are associated with one of the engagement portions 66. One of the two hooked portions 26 is engaged with the first portion 663 of the hooking portion 662. The other of the two hooked portions 26 is engaged with the second portion 664 of the hooking portion 662. The hooked portion 26 may be engaged with the hooking portion 662 with at least a part of the hooked portion 26 overlapping the hooking portion 662 from the downstream side s2 in the flow direction DF. In the example illustrated in FIG. 9, a part of the hooked portion 26 overlaps the hooking portion 662 from the downstream side s2 in the flow direction DF when the engagement portion 66 is engaged with the case 20. The engagement of the engagement portion 66 with the case 20 can be stably maintained by the hooked portion 26.

In the present exemplary embodiment, the case 20 further includes a cut portion 253 provided in the inner wall 251 of the communicating portion 25. The cut portion 253 is provided to connect the hole 252 of the communicating portion 25 with the groove portion 37. The cut portion 253 is provided so that one cut portion 253 is associated with one of the engagement portions 66. At least a part of the extension 661 of the engagement portion 66 is positioned in the cut portion 253. In the example illustrated in FIG. 9, a part of the extension 661 is positioned in the cut portion 253. The above-described cut portion 253 allows at least a part of the engagement portion 66 to be located at an inner side of the inner wall 251 while a part of the gasket 65 other than the engagement portion 66 is located at an outer side of the inner wall 251. In the present exemplary embodiment, the groove portion 37 is located at an outer side with respect to the inner wall 251. In this case, while the gasket body 67 is received in the groove portion 37, at least a part of the engagement portion 66 can be located at an inner side of the inner wall 251. Each of the gasket body 67 and the engagement portion 66 can thus be located at an appropriate position for achieving the function thereof.

In the example illustrated in FIG. 9, one cut portion 253 is provided between the two hooked portions 26, which are associated with one of the engagement portions 66, in the circumferential direction D2. In other words, the two hooked portions 26 are associated with one cut portion 253.

At least a part of the engagement portion 66 overlaps the reinforcing portion 39 in the flow direction DF. At least a part of the engagement portion 66 may overlap a part the reinforcing portion 39 connected to the inner wall 251 in the flow direction DF. At least a part of the engagement portion 66 may overlap the reinforcing portion 39 from the downstream side s2 in the flow direction DF. In the example illustrated in FIG. 9, a part of the engagement portion 66 overlaps the reinforcing portion 39 from the downstream side s2 in the flow direction DF. Specifically, a part of the engagement portion 66 overlaps the beam 52 of the reinforcing portion 39 from the downstream side s2 in the flow direction DF. Although not illustrated, at least a part of the engagement portion 66 may overlap the reinforcing portion 39 from the upstream side s1 in the flow direction DF.

At least a part of the extension 661 of the engagement portion 66 may overlap the reinforcing portion 39 in the flow direction DF. In the example illustrated in FIG. 9, a part of the extension 661 overlaps the reinforcing portion 39 from the downstream side s2 in the flow direction DF. Specifically, a part of the extension 661 overlaps the beam 52 of the reinforcing portion 39 from the downstream side s2 in the flow direction DF.

The engagement portion 66 may include a part not overlapping the reinforcing portion 39 in the flow direction DF. The hooking portion 662 of the engagement portion 66 may include a part not overlapping the reinforcing portion 39 in the flow direction DF. In the example illustrated in FIG. 9, the hooking portion 662 does not overlap the reinforcing portion 39 in the flow direction DF. Although not illustrated, at least a part of the hooking portion 662 may overlap the reinforcing portion 39 in the flow direction DF. At least a part of the hooking portion 662 may overlap the reinforcing portion 39 from the downstream side s2 in the flow direction DF. At least a part of the hooking portion 662 may overlap the beam 52 of the reinforcing portion 39 from the downstream side s2 in the flow direction DF.

In the present exemplary embodiment, the gasket 65 includes a plurality of the engagement portions 66. In this case, at least one of the engagement portions 66 may be in the above-described positional relationship with the reinforcing portion 39. For example, at least one of the engagement portions 66 may overlap the reinforcing portion 39 in the flow direction DF. All of the engagement portions 66 may be in the above-described positional relationship with the reinforcing portion 39. For example, all of the engagement portions 66 may overlap the reinforcing portion 39 in the flow direction DF. In the example illustrated in FIG. 9, the reinforcing portion 39 is connected to a plurality of points on the inner wall 251 of the communicating portion 25. Each of the engagement portions 66 overlaps corresponding part of the reinforcing portion 39 connected to the inner wall 251 in the flow direction DF.

The advantages of the at least a part of the engagement portion 66 overlapping the reinforcing portion 39 in the flow direction DF will be described below. An instance for forming the engagement portion 66 on the gasket 65, where the engagement portion 66 is formed at an outer side of the gasket body 67, is assumed. In this case, the size of the gasket 65 increases by the engagement portion 66 formed on the outer side of the gasket body 67. In addition, the outer side of the gasket body 67 is more susceptible to infiltration of fluid (e.g., water) from the outside of the structural component 10 than the inner side of the gasket body 67. The contact of the fluid infiltrating from the outside with the engagement portion 66 possibly causes disengagement of the engagement portion 66, displacement of the gasket 65, and/or degradation of the engagement portion 66. In view of the above, it is preferable that the engagement portion 66 is provided on the inner side of the gasket body 67.

However, when the engagement portion 66 is formed on the inner side of the gasket body 67, the engagement portion 66 necessarily protrudes into the hole 252 of the communicating portion 25. As a comparative example for forming the engagement portion 66 on the inner side of the gasket body 67, an instance, where the engagement portion 66 does not overlap the reinforcing portion 39 in the flow direction DF, is assumed. In this case, the engagement portion 66 is possibly directly hit by the fluid flowing in the communicating portion 25. Accordingly, it is possible that the engagement portion 66 is disengaged from the case 20 due to the fluid directly hitting thereon. In addition, it is possible that pressure loss of the fluid flowing through the communicating portion 25 is caused when the fluid directly hits the engagement portion 66.

In contrast, with at least a part of the engagement portion 66 overlapping the reinforcing portion 39 in the flow direction DF, the disadvantages caused when the fluid flows in the communicating portion 25 to directly hit the engagement portion 66 can be suppressed. Especially, when at least a part of the engagement portion 66 overlaps the reinforcing portion 39 from the downstream side s2 in the flow direction DF, the engagement portion 66 is protected by the reinforcing portion 39 from being directly hit by the fluid. Accordingly, this suppresses disengagement of the engagement portion 66 from the case 20 due to the fluid directly hitting thereon. When at least a part of the engagement portion 66 overlaps the reinforcing portion 39 from the upstream side s1 in the flow direction DF, the engagement portion 66 is supported by the reinforcing portion 39 from the downstream side s2 in the flow direction DF. Accordingly, even when the engagement portion 66 is directly hit by the fluid, the support by the reinforcing portion 39 suppresses disengagement of the engagement portion 66 from the case 20.

Alternatively, when at least a part of the engagement portion 66 overlaps the reinforcing portion 39 in the flow direction DF, the ratio of the area occupied by the engagement portion 66 or the reinforcing portion 39 to the entirety of the area surrounded by the inner wall 251 of the communicating portion 25 in a plan view decreases as compared with an instance where the engagement portion 66 does not overlap the reinforcing portion 39. The pressure loss caused when the fluid directly hits the engagement portion 66 or the reinforcing portion 39 can thus be suppressed.

As described above, with at least a part of the engagement portion 66 overlapping the reinforcing portion 39 in the flow direction DF, the disadvantages caused when the fluid flowing in the communicating portion 25 of the case 20 directly hits the engagement portion 66 of the gasket 65 can be suppressed. Specifically, disengagement of the engagement portion 66 from the case 20 and the pressure loss of the fluid flowing through the communicating portion 25 can be suppressed.

Especially, the following advantages can be achieved by overlapping at least a part of the extension 661 of the engagement portion 66 with the reinforcing portion 39 in the flow direction DF. The extension 661, which is different from the hooking portion 662 engaged with the case 20, is a part that is present between the hooking portion 662 and the inner wall 251. At least a part of the extension 661, which overlaps the reinforcing portion 39 as described above, is protected or supported thereby. Further, with the hooking portion 662 being engaged with the case 20, the position of the engagement portion 66 can be stably maintained. Accordingly, the engagement of the engagement portion 66 with the case 20 can be more stably maintained.

In the example illustrated in FIG. 10, the hooked portion 26 is engaged with the part of the hooking portion 662 not overlapping the reinforcing portion 39 in a plan view. The following advantages can thus be achieved. The hooked portion 26 can be brought into engagement with the part of the hooking portion 662 not overlapping the reinforcing portion 39 in a plan view and thus not protected or supported by the reinforcing portion 39. The position of the engagement portion 66 can thus be more stably kept. Especially, the position of the engagement portion 66 can be more stably kept without requiring the design of the reinforcing portion 39 to be modified so that the hooking portion 662 is protected or supported by the reinforcing portion 39. Accordingly, the engagement of the engagement portion 66 with the case 20 can be more stably maintained.

Although not illustrated, the reinforcing portion 39 may have a part overlapping the hooked portion 26 from the upstream side s1 in the flow direction DF. In this case, at least a part of the hooked portion 26 can be protected by the reinforcing portion 39 from being directly hit by the fluid. Especially, when at least a part of the hooked portion 26 overlaps the hooking portion 662 from the downstream side s2 in the flow direction DF, the reinforcing portion 39 may have a part overlapping the hooking portion 662 from the upstream side s1 in the flow direction DF. In this case, at least a part of the hooking portion 662 may be held between the hooked portion 26 and the reinforcing portion 39 in the flow direction DF. The engagement of the engagement portion 66 with the case 20 can be more stably maintained by holding at least a part of the hooking portion 662 between the hooked portion 26 and the reinforcing portion 39 in the flow direction DF.

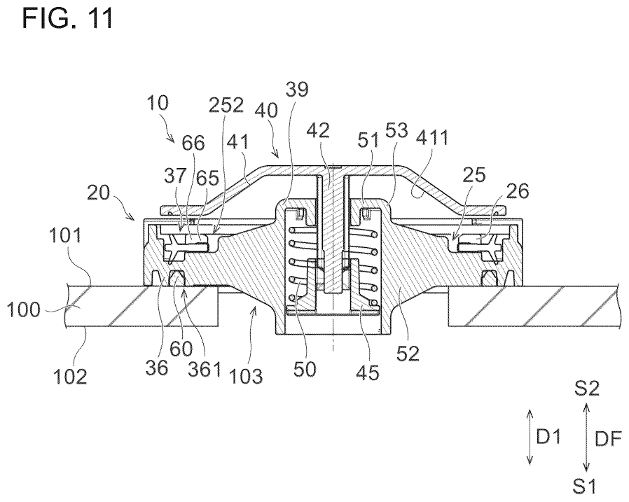

FIG. 11 is a cross-sectional view illustrating an example of an operation of the structural component 10, which is configured as a pressure relief valve. When the pressure inside the target object 100 exceeds a threshold, the valve member 40 moves so that the cover 41 moves away from the case 20 in the first direction D1. A flow path is thus created between the cover 41 and the case 20.

As fluid such as gas or the like inside the target object 100 is released through the flow path to the outside of the structural component 10, the pressure inside the target object 100 decreases. When, for example, the target object 100 is a battery pack housing, the explosion of the battery pack thus can be prevented. As described above, the structural component 10 configured as a pressure relief valve contributes to the improvement of safety of the battery pack.

When the pressure inside the target object 100 becomes smaller than the force applied to the valve member 40 by the elastic member 50, the valve member 40 moves toward the case 20. The flow path 103 of the target object 100 is thus sealed again by the valve member 40.

It is also possible to combine multiple components disclosed in the above exemplary embodiment as necessary. Alternatively, some component(s) may be removed from all the components described in the above exemplary embodiment.

While the invention has been explained with reference to the specific embodiments of the invention, the invention is not limited to the embodiments, and the invention is limited by the appended claims.

### REFERENCE SIGNS LIST

10 Structural component
20 Case
25 Communicating portion
251 Inner wall
253 Cut portion
26 Hooked portion
39 Reinforcing portion
40 Valve member
41 Cover
65 Gasket
66 Engagement portion
661 Extension
662 Hooking portion
67 Gasket body
671 Inner peripheral portion
100 Target object
101 Top surface

What is claimed is:

1. A structural component configured to be attached to a surface of a target object including a flow path, the structural component comprising:
a case including a communicating portion that is configured to communicate with the flow path of the target object, and a reinforcing portion connected to at least two points on an inner wall of the communicating portion; and
a gasket provided to the case on a downstream side in a flow direction of a fluid in the communicating portion, the gasket surrounding the communicating portion in a plan view, wherein
the gasket includes an engagement portion engaging the case, and
at least a part of the engagement portion overlaps the reinforcing portion in the flow direction.

2. The structural component according to claim 1, further comprising:
a valve member including a cover that covers the communicating portion in a closed position, the valve member being movable from the closed position to open the communicating portion, wherein
the gasket is interposed between the case and the valve member.

3. The structural component according to claim 1, wherein a ratio of an area occupied by the reinforcing portion to an entire area surrounded by the inner wall of the communicating portion in a plan view is 20% or less.

4. The structural component according to claim 1, wherein at least a part of the engagement portion overlaps the reinforcing portion from a downstream side in the flow direction.

5. The structural component according to claim 1, wherein
the gasket further includes an annular gasket body, and
the engagement portion includes an extension extending from an inner peripheral portion of the gasket body and a hooking portion connected to the extension and engaged with the case.

6. The structural component according to claim 5, wherein at least a part of the extension overlaps the reinforcing portion in the flow direction.

7. The structural component according to claim 5, wherein
the case further includes a cut portion provided in the inner wall of the communicating portion, and
at least a part of the extension is positioned in the cut portion.

8. The structural component according to claim 5, wherein the case further includes a hooked portion provided to the communicating portion to be engaged with the hooking portion.

9. The structural component according to claim 8, wherein the hooked portion engages with a part of the hooking portion that does not overlap the reinforcing portion in a plan view.

10. The structural component according to claim 1, wherein the target object is an enclosure of a battery pack.
